(19) United States
(12) Patent Application Publication
(10) Pub. No.: US 2005/0205214 A1
(43) Pub. Date: Sep. 22, 2005

(54) Machine for fitting and removing tires of vehicle wheels

(75) Inventor: Marco Matteucci, Rio Saliceto (IT)

Correspondence Address: MODIANO & ASSOCIATI, Via Meravigli, 16, Milano, 20123, IT

(73) Assignee: SICAM S.R.L.

(21) Appl. No.: 11/059,671

(22) Filed: Feb. 17, 2005

(30) Foreign Application Priority Data
Feb. 27, 2004 (IT) MO2004A000044

(51) Int. Cl. B60C 25/132

(52) U.S. Cl. 157/1.1

(57) ABSTRACT

A machine for fitting and removing tires of vehicle wheels, which comprises a frame for supporting a movable structure that supports a grip and rotation member for rotating a vehicle wheel rim about a rotation axis, and an arm that supports a tool for fitting and/or removing a tire on and/or from the rim and can be arranged along a working direction that is perpendicular to the rotation axis; the structure comprises a first portion, which is movably associated with the frame, and a second portion, which is movably associated with the first portion and supports the grip and rotation member, the first and second portions cooperating with each other to position the grip and rotation member in a working configuration, with the rotation axis and the working direction incident and the circumferential portion of the wheel rim arranged proximate to the tool.

The present invention relates to a machine for fitting and removing tires of wheels, particularly heavy and large wheels.

### BACKGROUND OF THE INVENTION

Machines have long been known which are used to fit and remove tires on and from vehicle wheel rims and are conventionally known as tire changing machines.

These machines are constituted substantially by a supporting frame for means for gripping and turning a wheel rim being worked on about an axis and for a working assembly provided with one or more tools for fitting and removing the tire on and from the wheel rim.

These tools are commonly of two types: bead breaking tools and hook-like tools.

Bead breaking tools are suitable to be inserted between the beads of the tire and the corresponding annular folds of the wheel rim, so as to separate them and facilitate the subsequent insertion of a hook-like tool, which is generally curved and can move toward and away from the tire along the rotation axis of the wheel rim in order to push said beads inside or outside said annular folds.

There are many types of tire changing machine, with different shapes and dimensions depending on the size of the wheel rims and of the tires to be fitted/removed.

Tire changing machines intended for fitting and removing the tires of heavy and large wheels generally have an elongated rigid structure that supports the grip and rotation means at one end and is associated at the other end with the frame so as to be able to rotate about an oscillation axis that is substantially parallel to the rim rotation axis.

By way of conventional actuation means, the structure can be turned alternately about the oscillation axis so as to move the grip and rotation means along a circular path, for example in order to change their distance from the ground, facilitate the coupling/separation of the wheel rim with respect to the grip means, and position the tire in the correct working position with respect to the tools.

Moreover, the tools of tire changing machines for very heavy and large wheels are generally fitted on a movable arm, which can slide with respect to the frame on a slider that is engaged along a guide that is parallel to the wheel rim rotation axis.

The sliding of the slider with respect to the guide is such as to move the tools toward/away from the wheel both at the outer sidewall and at the inner sidewall of the tire, where the expression “outer sidewall” is used to reference the sidewall that remains visible when the wheel rim is fitted on the vehicle and the expression “inner sidewall” is used to reference the opposite sidewall.

The arm is commonly connected to the slider so that it can rotate about an axis that is parallel to the rotation axis of the wheel rim, but it can be fixed to it in a preset position in which the axis of said arm is arranged along a working direction that is perpendicular to the direction defined by the rotation and oscillation axes and intersects the circular path traced by the grip and rotation means.

The rotation of the structure about the oscillation axis is such, therefore, as to move the rim rotation axis toward the arm in order to allow the tools to be placed in contact with the beads of the tire.

These known machines are susceptible of further improvements aimed in particular at increasing their flexibility and efficiency in use.

During fitting and removal operations, the wheel rotation axis and the working direction along which the arm is arranged are often in fact inclined with respect to each other.

This causes imperfect operation of the tools, which are designed to work in a configuration in which the direction of the arm intersects the rotation axis; accordingly, work performed on the beads of the wheel by said tools may be imperfect and/or defective and may subject the tire and the machine to excessive workloads.

In particular, it is noted that known tire changing machines have massive mechanical elements, such as the structure that supports the wheel and the tool supporting arm, which work in a cantilevered condition and therefore can be subjected to substantial flexural loads.

The structure that rotates about the oscillation axis, further, has a mobility that is extensive but not always sufficient to arrange the grip means close to the ground in order to allow to grip wheel rims placed on the ground; accordingly, operators often have to resort to awkward operations for lifting/lowering the wheel by way of external lifting means.

### SUMMARY OF THE INVENTION

The aim of the present invention is to provide a machine for fitting and removing tires of vehicle wheels that allows to achieve these improvements, allowing to perform fitting and removal operations in optimum working conditions both for the tire and for the machine, in addition to simplifying considerably the interventions of the operator.

Within this aim, an object of the present invention is to provide a tire changing machine that is particularly compact, has limited dimensions and an optimized geometry, which allows to reduce the flexural loads of its components.

Another object of the present invention is to allow to grip the rims of wheels that rest on the ground and to perform subsequent removal without requiring external lifting means.

Another object of the present invention is to provide a structure that is simple, relatively easy to provide in practice, safe in use, effective in operation, and has a relatively low cost.

This aim and these and other objects that will become better apparent hereinafter are achieved by the present machine for fitting and removing tires of vehicle wheels, comprising at least one frame for supporting at least one movable structure and supporting grip and rotation means for gripping and rotating a vehicle wheel rim about a rotation axis, and at least one arm that supports at least one tool for fitting and/or removing a tire on and/or from said rim and can be arranged along a working direction that is substantially perpendicular to said rotation axis, characterized in that said structure comprises at least one first portion, which is movably associated with said frame, and at least one second portion, which is movably associated with said first portion and supports said grip and rotation means, said first and second portions being suitable to cooperate with each other in order to position said grip and rotation means in a working configuration, in which said rotation axis and said working direction are incident and the circumferential portion of said wheel rim is arranged proximate to said at least one tool.

### BRIEF DESCRIPTION OF THE DRAWINGS

Further characteristics and advantages of the present invention will become better apparent from the following detailed description of a preferred but not exclusive embodiment of a machine for fitting and removing tires of vehicle wheels, illustrated by way of non-limiting example in the accompanying drawings, wherein:

FIG. 1 is a schematic side view, partially in phantom lines, of a first embodiment of the machine according to the invention;

FIG. 2 is a schematic side view, partially in phantom lines, of a second embodiment of the machine according to the invention.

### DESCRIPTION OF THE PREFERRED EMBODIMENTS

With reference to the figures, the reference numeral 1 generally designates a machine for fitting and removing tires of vehicle wheels.

The machine 1 comprises a frame 2, which supports a structure 3 that can rotate alternately about a substantially horizontal oscillation axis O.

Grip and rotation means 4 for gripping and turning a vehicle wheel rim about a rotation axis R that is substantially parallel to the oscillation axis O are associated with said structure; the vehicle wheel is not shown in the figures, since it is of a known type.

Moreover, an arm 5 is associated with the frame 2 and supports, at one of its ends 5a, two tools 6, which are used to fit and/or remove a tire on and/or from the rim of the wheel.

Said tools are constituted by a bead breaking tool 6a, such as a conventional disk that can rotate about its own axis, and a hook-like tool 6b of the conventional type.

The arm 5 can move with respect to the frame 2 and in fact its end 5b that lies opposite the previous end 5a is connected to a slider 7 so that it can rotate about a direction that is parallel to the oscillation axis O.

In turn, the slider 7 is engaged in a guide 8 with which the frame 2 is provided; said guide runs along a direction that is parallel to the oscillation axis O.

The arm 5 is of the telescopic type, since it is constituted by two tubular elements 9, one of which can be inserted slidingly in the other.

It is noted that the coupling of the arm 5 to the frame 2 is such as to allow its movement while keeping its axis substantially perpendicular to the directions traced by the oscillation axis O and rotation axis R.

The mobility of the arm 5 can be reduced temporarily by way of removable locking means, which are not shown in the figures as they are of a conventional type, so as to allow its placement along a preset working direction L.

According to the invention, the structure 3 is constituted by a first portion 10a, which is pivoted to the frame 2 so that it can rotate about the oscillation axis O, and by a second portion 10b, which can move with respect to the first portion and supports the supporting means 4.

The first and second portions 10a and 10b are suitable to cooperate with each other in order to position the means 4 in a working configuration, in which the rotation axis R and the working direction L are mutually incident and the circumferential portion of the rim is arranged in the vicinity of the tools 6.

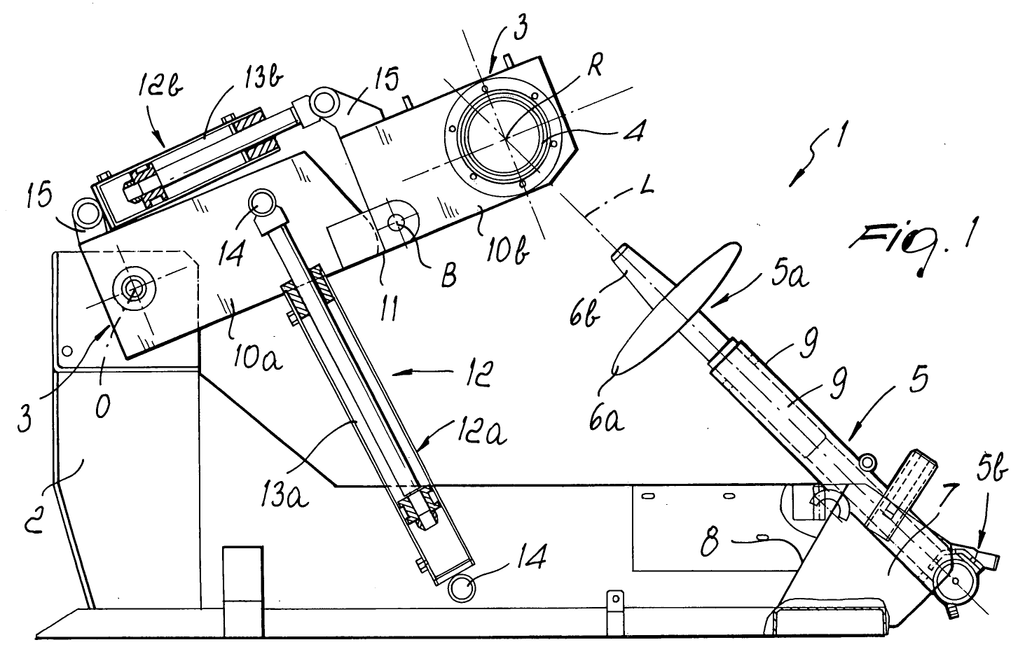

In a first embodiment of the present invention, shown in FIG. 1, the second portion 10b is associated with the first portion 10a so that it can rotate about a tilting axis B that is substantially parallel to the rotation axis R; the free end of the first portion 10a, in particular, is provided with a fork-like body 11, which protrudes longitudinally and at which the second portion 10b is pivoted.

In order to move the structure 3 with respect to the frame 2, the machine 1 is provided with actuation means 12 of the linear type as described hereinafter.

In particular, first actuation means 12a for actuating the rotation of the first portion 10a about the oscillation axis O are provided; they are advantageously of the type of a first jack 13a with ends that are rotatably associated respectively with the frame 2 and with the first portion 10a at two points 14 that are separate from the oscillation axis O.

Further, the machine 1 is provided with second actuation means 12b for actuating the rotation of the second portion 10b about the tilting axis B, which conveniently comprise a second jack 13b with ends that are respectively associated so that they can rotate with two brackets 15 that protrude upward from the first portion 10a and from the second portion 10b.

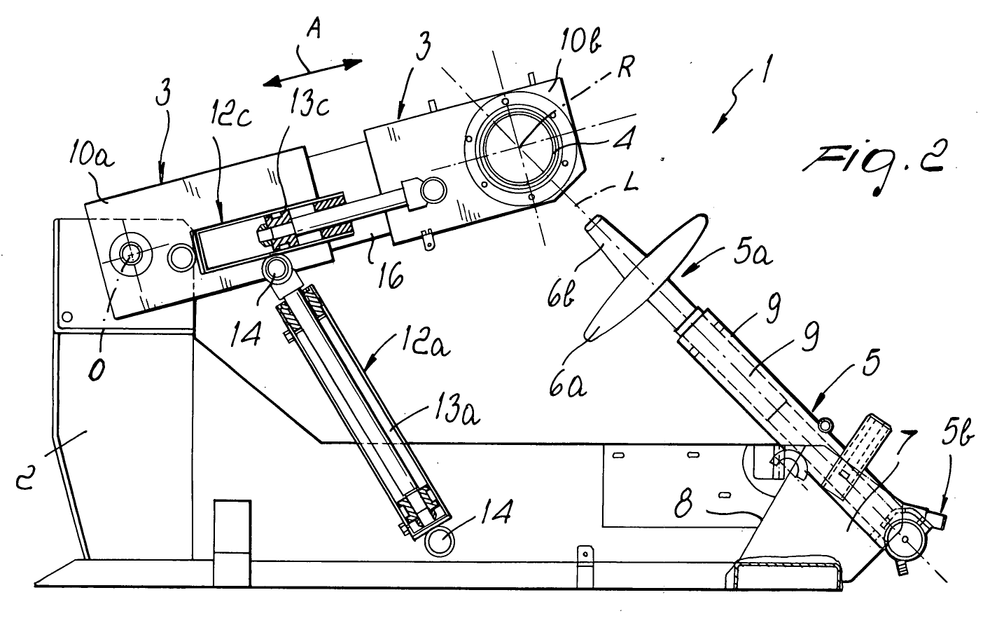

In a second embodiment of the present invention, shown in FIG. 2, the first portion 10a and the second portion 10b are mutually connected so that they can slide along a direction that is substantially perpendicular to the rotation axis R and is illustrated by means of the arrow A in FIG. 2.

In this embodiment, the first portion 10a and the second portion 10b are constituted, respectively, by a first body tubular body and a second tubular body, which have an elongated shape, are aligned along the direction A, and are mutually coaxial.

In particular, the second body 10b has a portion 16 that is inserted so that it can slide along the direction A within the first body 10a, which acts as a guide.

The machine 1 shown in FIG. 2, as well as the machine related to FIG. 1, is provided with actuation means 12 that are of the linear type, which can be actuated on command.

For the movement of the first portion 10a with respect to the frame 2, reference is made to what has been specified above with regard to the first actuation means 12a.

For the movement of the second portion 10b with respect to the first portion 10a, there are instead third actuation means 12c for actuating the sliding of one portion with respect to the other along the direction A.

Advantageously, said third actuation means are constituted by a third jack 13c, which is aligned with the direction A and in which the ends are associated with the respective portions 10a and 10b.

In the two embodiments of the machine 1 shown in FIGS. 1 and 2, the actuation means 12 (12a, 12b, 12c) are shown as being of the fluid-operated (hydraulic or pneumatic) linear type, but alternative embodiments can be used also, in which they are rotary, and/or they are electrically-operated or are actuation means of other suitable type.

The operation of the present invention is as follows: initially, the wheel rim must be fitted on the means 4 in a manner similar to that of conventional machines.

Both during fitting and during removal of the tire on and from the wheel rim, the first and second portions 10a and 10b may be moved by acting independently on the respective actuation means 12 until the working configuration is reached.

Finally, by way of the sliding of the slider 7 along the guide 8 it is possible to arrange the tools 6 in contact with the bead of the tire, keeping the rotation axis R and the working direction L incident to each other.

In practice it has been found that the described invention achieves the proposed aim and objects, and in particular the fact is stressed that it allows to improve operation and increase efficiency and flexibility of use with respects to conventional machines.

The particular refinement of using two portions that can move with respect to each other in fact provides the structure for supporting the grip and rotation means with two degrees of freedom instead of one as in known tire changing machines; this allows to position said means in a working configuration in which the rotation axis and the working direction are mutually incident, allowing to use the tools in an optimum manner and to distribute in a less stressful manner the workloads generated during fitting/removal on the tire and on the machine.

Besides, it is noted that in conventional machines such a working configuration can be obtained only for particular dimensions of the wheel rims fitted on the grip and rotation means, whereas in the present invention the rotation axis and the working direction may be arranged easily so that they are incident regardless of the extension of the wheel rim.

The two degrees of freedom given to the structure that supports the wheel, further, allow to obtain a tire changing machine that is capable of working in more compact configurations than conventional machines and in which the flexural loads of the cantilevered mechanical elements are particularly modest.

Finally, it is noted that the wheel supporting structure has a mobility that allows to position the grip means proximate to wheel rims that are resting on the ground, in order to allow to grip them without resorting to external lifting means; likewise, the same advantage can be observed during removal of the wheel from the grip means.

The invention thus conceived is susceptible of numerous modifications and variations, all of which are within the scope of the appended claims.

All the details may further be replaced with other technically equivalent elements.

In practice, the materials used, as well as the contingent shapes and dimensions, may be any according to requirements without thereby abandoning the scope of the protection of the appended claims.

The disclosures in Italian Patent Application No. M02004A000044 from which this application claims priority are incorporated herein by reference.

1. A machine for fitting and removing tires of vehicle wheels, comprising: at least one frame; at least one movable structure; grip and rotation means for gripping and rotating a vehicle wheel rim about a rotation axis; and at least one arm that supports at least one tool for fitting and/or removing a tire on and/or from the rim, said movable structure, said grip and rotation means and said at least one arm being supported at said frame, said at least one arm being arrangeable along a working direction that is substantially perpendicular to said rotation axis; and wherein said movable structure comprises at least one first portion, which is movably associated with said frame, and at least one second portion, which is movably associated with said first port-ion and supports said grip and rotation means, said first and second portions being adapted to cooperate with each other in order to position said grip and rotation means in a working configuration, in which said rotation axis and said working direction are incident and a circumferential portion of said wheel rim is arranged proximate to said at least one tool.

2. The machine of claim 1, wherein said first portion is associated with said frame so as to be rotatable about an oscillation axis that is substantially parallel to said rotation axis.

3. The machine of claim 1, wherein said second portion is associated with said first portion so as to be rotatable about a tilting axis that is substantially parallel to said rotation axis.

4. The machine of claim 1, wherein said second portion is associated with said first portion so as to be slideable along a direction that is substantially perpendicular to said rotation axis.

5. The machine of claim 1, wherein said first and second portions respectively comprise at least one first body and one second body that have a substantially elongated shape, at least one of said first and second bodies being substantially tubular, the second body being associated so as to be slideable along the first body.

6. The machine of claim 2, comprising first actuation means for actuating said first portion for rotation about said oscillation axis.

7. The machine of claim 6, comprising second actuation means for actuating rotation of said second portion about said tilting axis.

8. The machine of claim 7, comprising third actuation means for actuating said second portion for performing sliding with respect to said first portion.

9. The machine of claim 8, wherein at least one of said first, second and third actuation means is of a linear type.

10. The machine of claim 8, wherein at least one of said first, second and third actuation means is actuatable on command.

11. The machine of claim 10, wherein at least one of said first, second and third actuation means is of an electrically-operated type.

12. The machine of claim 10, wherein at least one of said first, second and third actuation means is of a fluid-operated type.

13. The machine of claim 12, wherein said first actuation means comprise at least one first jack, having ends thereof which are associated for rotation with said frame and with said first portion, respectively.

14. The machine of claim 13, wherein said second actuation means comprises at least one second jack having ends thereof, which are associated for rotation with said first portion and with said second portion, respectively.

15. The machine of claim 14, wherein said actuation means comprises at least one third jack, having ends thereof which are associated with said first portion and with said second portion, respectively.
